(19) United States
(12) Patent Application Publication
(10) Pub. No.: US 2020/0009480 A1
(43) Pub. Date: Jan. 9, 2020

(54) SYSTEM AND METHOD FOR SELECTIVELY HARVESTING STORAGE WATER

(71) Applicant: IXOM Operations Pty Ltd, East Melbourne (AU)

(72) Inventors: Christopher S. Keever, Peachtree, GA (US); Kelly B. McCurry, Parker, CO (US)

(73) Assignee: IXOM Operations Pty Ltd, East Melbourne (AU)

(21) Appl. No.: 16/483,333

(22) PCT Filed: Feb. 1, 2018
(86) PCT No.: PCT/IB2018/050617

§ 371 Date: Aug. 2, 2019

Related U.S. Application Data
(60) Provisional application No. 62/454,351, filed on Feb. 3, 2017.

(30) Foreign Application Priority Data
Jun. 7, 2017 (AU) 2017902179

(51) Int. Cl. B01D 21/24; B01D 21/00

(52) U.S. Cl. CPC B01D 21/2422; B01D 21/0042

(57) ABSTRACT

A system for use with a water storage facility having a water body and an extraction structure, comprising a water selection apparatus interposed between the water body and the extraction structure. A controllable inlet allows water from a selectable depth within the water body to be harvested for withdrawal through the extraction structure, controlled according to detected differences in the water quality characteristics as between different depths. A barrier structure forms a partitioned volume allowing water from a select depth to be separated and isolated within the water body. Water at variable depths can be dynamically separated and isolated based on water quality criteria and/or characteristics, and potentially changing criteria. This may facilitate treatment and/or conditioning of the separated and isolated water prior to being extracted through a harvesting structure having fixed-elevation extraction point(s).

### FIELD

This invention relates to a system and method for selectively harvesting and optionally treating water for withdrawal from a storage reservoir or the like.

### BACKGROUND

Any discussion of documents, devices, acts or knowledge in this specification is included to explain the context of the invention. It should not be taken as an admission that any of the material forms part of the prior art base or common general knowledge in the relevant art in Australia or elsewhere on or before the priority date of the disclosure and claims herein.

Water quality and characteristics within a surface water source (e.g. reservoir, lake, lagoon, catchment, etc.) can vary significantly as a function of depth and/or location within the water body. Cool, dense water at lower depths may contain high concentrations of metals, hydrogen sulfide, nutrients, and biomass from decaying organic matter. Warm, sunlit layers near the surface can experience wide swings in water characteristics due to photosynthesis and the algae respiration cycle. Water acidity may even vary across the course of a day, for example from pH 6.5 early in the morning to pH 8.5 late in the afternoon. Seasonally, a reservoir can experience “turnover” events where bottom layers of water reverse positions with those that were closer to the surface. Water at the surface can have negligible manganese levels on one day, for example, then after turnover it can dramatically increase. Although water characteristics in a given layer of water can remain constant during certain periods of the year, and be consistent throughout a reservoir, in some circumstances they can be expected to change at least seasonally and sometimes weekly, daily, or even hourly.

Reservoir water temperature and other characteristics are important because they may impact upon downstream processes that utilize water from the reservoir. Utilities, for example, will treat raw water with various chemicals and processes in order to make it suitable as public drinking water. Power plants are another example where not only does the water source require treatment, but the temperature of the water can impact power production.

FIG. 1 of the accompanying drawings is a diagrammatic illustration of a power plant. From this diagram it can readily be discerned that the temperature of the water extracted from the reservoir would have an impact on the cooling capability of the water within the cooling tower, and thus impact on the efficiency of the condenser. The characteristics of this water are also important because it should remain within certain water quality parameters to be used for the power plant processes. Corrosiveness and pH of the water are extremely important, for example. So on one hand, it is desirable to have the coolest water possible, but the quality of the water is equally important.

The withdrawal of water out of a reservoir is accomplished through and only adjacent to an intake structure. A typical intake structure has one or more gates or withdrawal points at fixed elevations within the water body (FIG. 2). For example, one gate may be near the reservoir floor, with a small number of others located at intervals up to the maximum pool level. Ordinarily water will be withdrawn from the top of the reservoir by opening an uppermost gate or valve (gate) to extract water. If the water level within the reservoir falls below that gate then the next gate at a lower elevation will be opened to withdraw water.

Although drawing water from an uppermost gate is usually the preferred approach to extracting water from a reservoir, it can present some challenges. Since water near the surface may contain algae, and algae goes through a respiration cycle each day, water near the surface can have widely varying pH and dissolved oxygen levels. This can be problematic for chemical dosing schemes and treatment processes, and significantly add to the overall cost of treatment. Algae can contribute greatly to taste and odor excursions, particularly when certain bacteria die and Methyl-Isoborneol (MIB) and Geosmin are released into the water. There may be no greater cost of treatment than that associated with removing taste and odor compounds from public drinking water.

In view of the foregoing, the inventor has realised that it would be desirable to enable water withdrawal from a reservoir from a selected water depth and/or from one or more selected locations within or in the vicinity of the water body in order to obtain particular water characteristics in the withdrawn water. Moreover, the inventor has recognised that there may be beneficial outcomes that can be achieved if a system for dynamically selecting water for withdrawal can be retrofitted to intake structures of existing reservoirs.

### SUMMARY

In accordance with the present invention there is provided a system for use with a water storage facility having a water body and an extraction structure, the system comprising a water selection apparatus interposed between the water body and the extraction structure, the water selection apparatus having a controllable inlet that allows water from a selectable depth within the water body to be harvested for withdrawal through the extraction structure.

In accordance with the present invention there is also provided a system for use with a water storage facility having a water body and an extractions structure, the system comprising a water selection and relocation apparatus installed within or in the near vicinity of the water body having a controllable inlet that allows water from a selectable location remote from the extraction structure to be relocated directly to the extraction structure for withdrawal through the extraction structure.

A barrier structure may be provided forming a partitioned volume enclosing or attached to the extraction structure wherein the water selection apparatus controls water flow from the water body to the partitioned volume.

The water selection apparatus may comprise a selector interface integrated with the barrier structure and including a plurality of selector gates positioned at respective depths in the water body, the gates being selectively operable to admit water from the corresponding depth to the partitioned volume. Alternatively, the water selection apparatus may comprise a fluid conduit such as a pipe having an inlet that is moveable to a selected depth within the water body and an outlet in the partitioned volume.

A monitoring apparatus may be provided, arranged for measuring and monitoring at least one water quality characteristic over at a plurality of depths within the water body, wherein the water selection apparatus is controlled according to detected differences in the at least one water quality characteristic as between different depths.

In accordance with another aspect of the present invention, there is provided a method for controlling the quality of water for withdrawal from a water body by way of an extraction structure, the method comprising selectively harvesting water from a dynamically controllable depth within the water body before admitting the harvested water for withdrawal through the extraction structure.

The method may include monitoring at least one water quality characteristic over at a plurality of depths within the water body and controlling the depth at which water is harvested according to detected differences in the at least one water quality characteristic as between different depths.

The method may include retaining the harvested water in a partitioned volume of the water body before withdrawal through the extraction structure. At least one water treatment steps or processes may be applied to the water in the partitioned volume prior to withdrawal through the extraction structure.

The method and apparatus according to embodiments of the invention allows for the dynamic withdrawal and/or harvesting of water within a water body at depths corresponding to not only those established by the withdrawal structure's fixed-elevation extraction points (e.g. gates, valves, weirs, etc.), but also additional depths above, below, or between the fixed-elevation extraction points. This may allow water to be harvested at continuous depths, or any depth, or multiple depths.

Embodiments of the invention allow water at a select depth or depths to be separated and isolated within the water body. Water at variable depths can be dynamically separated and isolated based on water quality criteria and/or characteristics, and potentially changing criteria. This may facilitate treatment and/or conditioning of the separated and isolated water prior to being extracted through a harvesting structure having fixed-elevation extraction point(s). Treatments may include aeration, oxidation, coagulation, adsorption, absorption, flotation, skimming, heating, cooling, disinfection or other forms of physical/chemical/thermal treatment of the separated and isolated water. Multiple stages of treatment and/or separate zones of treatment may be employed.

Embodiments of the invention provide for monitoring water quality and characteristics as a function of depth within the water body.

In embodiments of the invention a barrier may be installed within the body of water to isolate water of varying quality and characteristics. The barrier may be rigid as in construction from concrete, metal, or earth. Alternatively the barrier may be flexible in the form of a baffle curtain or the like. Pressure relief mechanisms may be incorporated within the barrier structure to ensure the structural integrity of the water quality barrier is not compromised.

The barrier structure may be vertical in the water column, or angled. The barrier may be collapsible/expandable/flexible with changing water level in the body of water. The barrier may preferably be of a dimensional size and volume to create sufficient detention/residence time for the selected water to undergo treatment based on the maximum harvesting rate of the water. For example, the barrier may be of dimensional size and volume to create a minimum of five minutes of residence time for the harvested water before it is withdrawn.

The apparatus used to separate water within the water body is preferably designed with sufficiently minimal head-loss so as to not compromise the structural integrity of the water quality barrier. With that in mind, the system may be designed in a way that at least some portion of the apparatus is always open to allow for the transmission of water across the apparatus.

The water selection apparatus may utilize one or more orifices—gates, windows, or openings—for permitting water flow from one side of the barrier to the other. The gates or windows within the apparatus may be dynamically opened or closed through manual, pneumatic, mechanical, hydraulic, electric, or mechanical means. The gates preferably minimize or eliminate the transmission of water when closed, but may open in the event pressure relief is needed across the barrier.

In another form the water selection apparatus may utilize one or more pipes or conduits that are fixed to the water quality barrier. partitioned volume or extraction structure on one end, and raised and lowered on the other end to allow for the transmission of water at select depth(s) to be drawn into the partitioned volume defined by the barrier or directly into the extraction structure. The pipes may be constructed of various different types of material, such as HDPE, fiberglass, PVC, steel, rubber or similar flexible material, or concrete.

In another form the water selection apparatus may utilize a means to select a preferred water from one or more locations within or in the vicinity of the water body whereby the preferred water may be relocated by gravity or by pumping directly to the water quality barrier or to the extraction structure.

In embodiments of the invention, quality characteristics of the water are monitored as a function of depth within a water body and/or location about the water body, to enable identification of a depth or location or multiple depths or locations of water that may exhibit preferred water quality characteristics based on select parameter(s), and to permit an operator to be alerted of preferred water available for harvesting or extraction, and possible automatic selection of preferred water for harvesting or extraction. A process operator may be provided with a choice to select water from the main water body, based on dynamically measured water quality parameters, as a function of depth and/or location within the main water body, and a physical mechanism (gate, valve, window, slot, orifice, pipe, weir, flap, louver, port, entrance, inlet, skimmer, decanter, etc.) which can be controlled, opened, closed, raised, lowered, rotated, swiveled, angled, turned, and adjusted, as necessary to allow for water from the selected depth and/or location to be collected independently from water at depths above or below the selected depth or from location(s) separate from the selected location(s).

### BRIEF DESCRIPTION OF THE DRAWINGS

Further disclosure, objects, advantages and aspects of the present invention may be better understood by those skilled in the relevant art by reference to the following description of several embodiments thereof taken in conjunction with the accompanying drawings, which are given by way of illustration only and thus not limitative of the present invention, and in which:

FIG. 1 is a diagrammatic illustration of a power plant with cooling water reservoir;

FIG. 2 shows examples of intake gates within reservoirs;

FIG. 3 is a chart illustrating water quality characteristics as a function of depth and time of year;

FIG. 4 is a diagrammatic isometric view of a baffle barrier with integral water selector interface according to an embodiment of the invention;

FIG. 4A shows an exemplary layout arrangement of selector gates on the selector interface of FIG. 4;

FIG. 5 is a diagrammatic sectional illustration of a water selector gate that may be used in embodiments of the invention;

FIG. 6 is a diagrammatic section view of a system installation according to an embodiment of the invention;

FIG. 7 is a diagrammatic plan view of a system installation according to an embodiment of the invention;

FIG. 8 is a diagrammatic section view of a system installation according to an embodiment of the invention;

FIG. 9 is a diagrammatic section view of a system installation according to an embodiment of the invention;

FIG. 10 is a diagrammatic sectional view of an adjustable submerged intake apparatus according to an embodiment of the invention;

FIG. 11 is a diagrammatic sectional view of selectable submerged intake apparatus according to an embodiment of the invention;

FIG. 12 is a diagrammatic plan view of a preferred water relocation system according to an embodiment of the invention;

FIGS. 13 and 14 are diagrammatic system illustrations showing various features of possible embodiments of the invention;

FIG. 15 is a diagrammatic isometric view of a system installation according to another embodiment of the invention; and

FIGS. 16-19 are graphs of experimentally measured water quality characteristics as a function of depth.

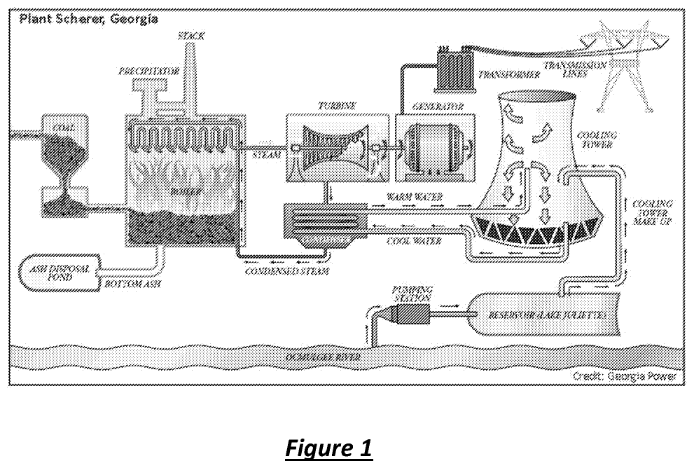

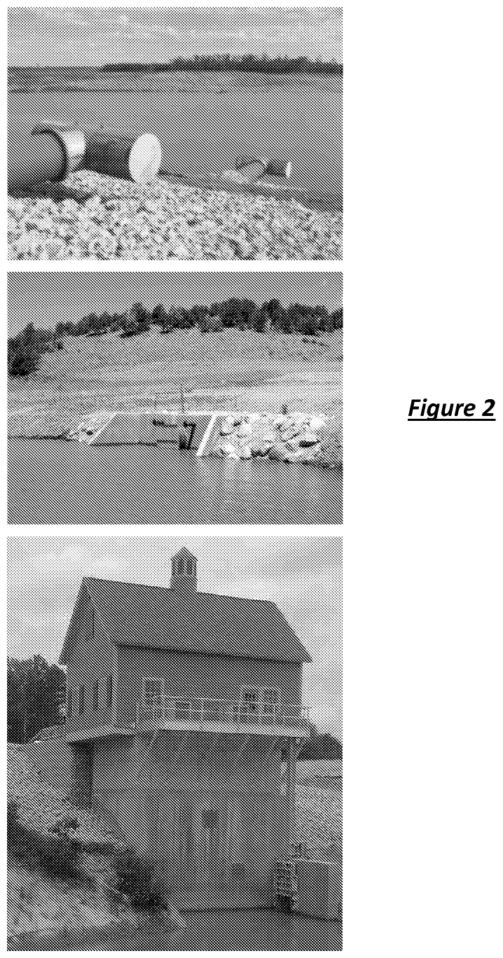

### DETAILED DESCRIPTION

Embodiments of the invention provide a method and apparatus that dynamically monitors water quality characteristics within a body of water; provides information to assist with identification and selection or directly identifies and selects water of preferred characteristic(s) for extraction/harvesting; separates and isolates this selected water from the water body—possibly within the water body; and provides for the possible treatment of selected water prior to extraction/harvesting. Thus, the process according to embodiments of the invention may be summarized as:

MONITOR→SELECT→SEPARATE→(TREAT→) HARVEST

Before describing the various embodiments of the invention, it is worthwhile explaining the context of application in further detail.

Considering that water near the reservoir floor may be undesirable, and water near the surface can become undesirable at certain times, there may be a depth of water that might present the purest, most desirable or least-expensive-to-treat water for harvesting. This “ideal water extraction depth” may change throughout the course of the day, week, month, and year, and may be isolated to just a few feet of water depth within the water column. It is therefore desirable to monitor the water quality within a reservoir as a function of depth, and have the capability to extract water at a select depth on a dynamic basis.

Considering also that there are times throughout the year that water “turns over” within the water body creating undesirable water quality characteristics, there may be one or more locations about the water body that provide ideal source locations that are remote from the extraction structure. It is therefore desirable to monitor the water quality within a reservoir as a function of location about the water body, and have the capability to relocate and extract water from selected locations on a dynamic basis.

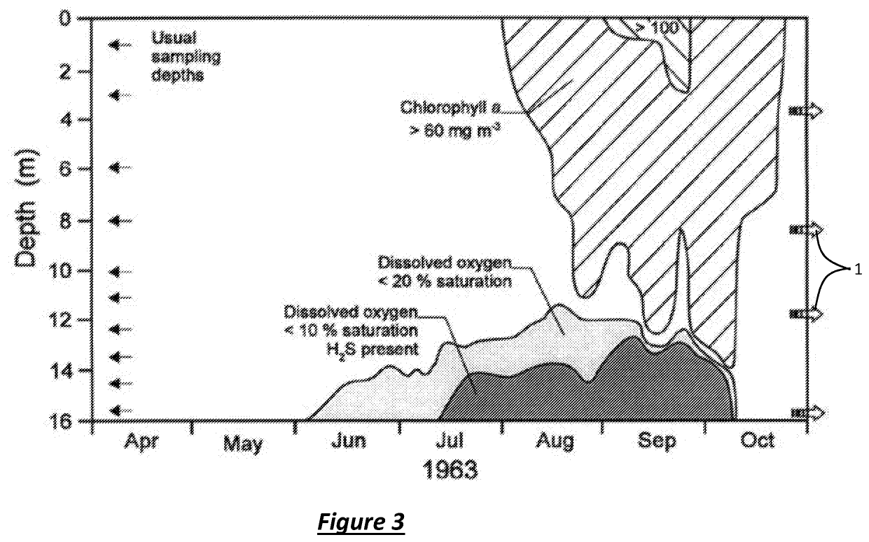

FIG. 3 graphically illustrates the variability of possible water quality characteristics over time as a function of depth. As can be seen from this diagram, depending on the time of year and depth within the water body, concentrations of contaminants can vary greatly. The arrows on the right side of the graph (indicated by reference numeral 1) represent the elevations of fixed intake gates supplying water to a treatment facility. So in August, for example, withdrawing water in the uppermost gate would be problematic due to the algae present near the surface, and water withdrawn from the lower two gates may present anoxic conditions and likely high soluble metal concentrations.

The chart shown in FIG. 3 also illustrates the potential for substantial variation in water characteristics over just a few feet of water depth. During the warmer (northern hemisphere summer) months, there can be very limited “slices” of water present in a water body that do not exhibit problematic characteristics. Depending on the spacing of the fixed-elevation gates in a harvesting structure, preferred water may be inaccessible.

It should be noted that the preferred water for extraction may be water of any select characteristic, including contaminated water and/or water of poor quality. Contaminants can accumulate at certain depths at different times of the year. By extracting this water, the water body can be remediated over time while also allowing for the possible treatment of this contaminated water prior to discharge/extraction. It may be that mixing this contaminated water with water from a different depth may successfully remediate and/or treat this water prior to discharge. Additionally, the extraction and removal of this contaminated water from a water body may be timed to coincide with rain events or times when a spillway may be actively purging water.

The primary components employed in embodiments of the invention are outlined below.

Sampler and Monitor

An apparatus adapted for sampling and/or monitoring various water quality parameters as a function of depth within the water body. Parameters may include, but are not limited to, pH, dissolved oxygen, turbidity, organic carbon, color, chlorophyll, conductivity, hydrogen sulfide, dissolved metals, temperature, ORP, and so forth.

Selector

An apparatus that allows for selection of the depth and/or location at which water is able to flow from the water body to a harvesting device such as an intake structure having fixed-elevation extraction points (gate, pipe, weir, etc.). The selector may be incorporated in the barrier separator (see below) positioned between the bulk of the water body and the intake structure. The depth selection may be made on the basis of water characteristics measured by the sampler and monitor apparatus.

Barrier Separator

A rigid or flexible barrier installed in a water body to contain and separate water of differing and variable water quality characteristics.

Treatment Equipment

Solutions implemented within the confines of the barrier separator that treat or condition the selected water.

Control System

Monitors and controls all components in the system, potentially communicating through SCADA architecture.

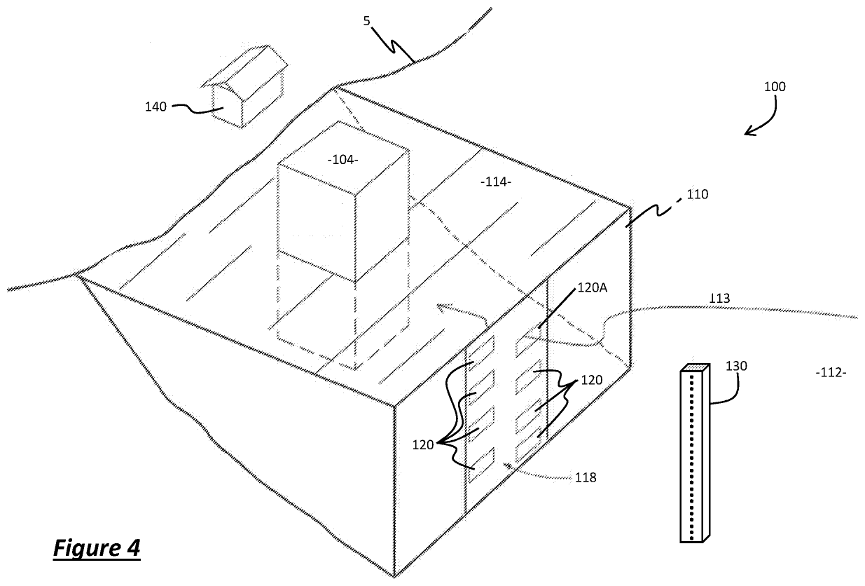

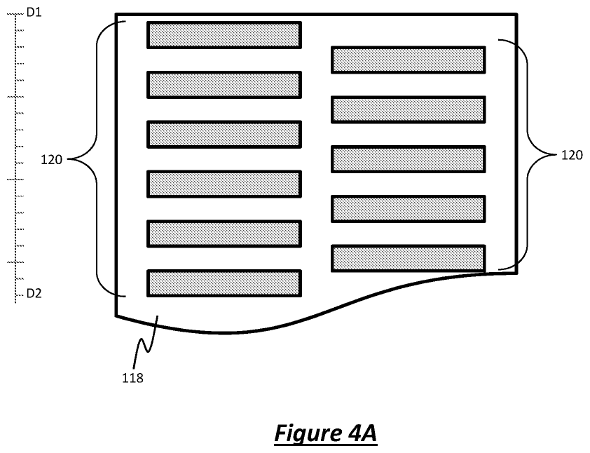

A system 100 according to an embodiment of the invention is shown in diagrammatic isometric view in FIG. 4 that is useful for describing the main features and explaining their operation. This drawing shows a portion of a water body (e.g. reservoir) along a shoreline 5 at which is located an existing intake structure 104. A barrier 110 is provided within the water body to partition a volume 114 surrounding the intake structure from the bulk of the reservoir 112. Integrated with the barrier 110 is a selector interface 118 having a plurality of selector gates 120. The selector gates 120 are arranged so that each gate is positioned at a particular depth below the water surface. Fluid communication between the main reservoir water bulk 112 and the partitioned volume 114 is by way of one ore more of the gates 120 which may be selectively opened and closed according to selection criteria.

The barrier 110 may comprise a baffle curtain or a permanent wall installed within the body of water, surrounding the existing harvesting (intake or outfall) structure. The barrier isolates water in the partitioned volume 114 from water in the reservoir and allows only water admitted through the selector interface to enter the partitioned volume. The barrier 110 is designed of a specific structural integrity and has features to ensure that water can always be admitted in and out of the enclosed volume without compromising the structural integrity of the barrier. For example, the barrier may incorporate features such as pressure relief, continuous bleed or other passive or active control means to avoid large pressure differentials across the barrier.

In embodiments of the invention the barrier separator may be in the form of a flexible baffle curtain constructed from nylon or the like. The baffle curtain may be supported by industrial strength floats at the top surface of the water, hanging down in the water column to the reservoir floor and secured by an anchor system concrete blocks and ballast such as steel chain sewn directly into a hem in the bottom of the baffle curtain. Baffle curtains suitable for the application may be sourced, for example, from JPS Industries of Bristol, N.H. U.S.A.

The system 100 also includes a water characteristic vertical profiling monitor 130 located in the main reservoir water body 112, preferably in the vicinity of the selector interface 118. There are a number of instrumentation solutions available to qualify water characteristics that may be suitable for use as the monitor 130 in embodiments of the invention. In general there are two options: one is to have an in-reservoir water sampling system that can sample water quality at various depths; the other is to pull water from various depths to the shore, or to a utility structure in the water body, and measure water quality parameters there using standard in-line or grab sample instruments.

As an example, suitable apparatus for performing the water characteristic monitoring functions are available from YSI Incorporated of Yellow Springs, Ohio U.S.A. Water quality profiling instrumentation, from YSI Systems, profiles the water at different depths throughout the Lake. YSI water quality sondes are equipped with sensors that measure dissolved oxygen, pH, turbidity, depth, temperature, specific conductance, and fluorescence. This monitoring apparatus may be based on an anchored floating platform with water monitoring instrumentation extending underneath and arranged to periodically sample and measure selected water characteristics at certain depth intervals in the water body. The frequency of sampling at each water depth may depend on the overall depth of the water body and the interval size, but might be expected to be of the order of hourly in a typical application. Data representing the measures water characteristics at the depth intervals can be hard-wired or wirelessly communicated to an on-shore installation (e.g. control and instrumentation equipment installation 140 illustrated in the drawings).

In operation, water quality and characteristics are measured and monitored outside the barrier separator 110 as a function of depth and/or location using the monitoring apparatus 130. Water monitoring data is communicated to the control and instrumentation equipment installation 140 which uses data processing techniques to analyze the data. Based on the data analysis, water at a specific depth is identified and selected for admission into the partitioned volume defined by the barrier 110 (preferred water). Preferred water from outside the barrier is admitted into the partitioned volume 114 through the selector interface 118. This is accomplished by selectively opening one or more of the selector gates 120 at depth(s) corresponding to that identified for the preferred water. In FIG. 4, water flow is indicated by arrow 113 through open gate 120A.

Water exits the partitioned volume defined by the barrier separator typically through a harvesting structure such as an intake structure, outfall structure, pipe, channel or weir, which would have fixed-elevation extraction point(s). The ingress and egress of water is preferably controlled so that as water exits and enters the partitioned volume, the water level differential across the barrier separator is small enough to not compromise the structural integrity and function of the barrier or unduly limit the water flow into the extraction structure.

The selector interface 118 incorporates dynamically operated orifices (gates 120) of a specific minimal size, particularly in the vertical dimension, so as to allow sufficiently thin layers of like water of preferred quality from outside the main reservoir 112 into the partitioned volume 114 defined by the barrier 110. The selector gates 120 can be dynamically operated by manual, electrical, hydraulic, mechanical, or pneumatic means according to signals from the control equipment 140.

It is preferred that the selector gate openings are of relatively restricted dimension vertically so as to, in use, admit water from only a restricted depth range in the water body. For example, the selector openings may typically be 12″ to 18″ tall, and as wide as reasonably possible, for example at least 96″ wide. It is advantageous for the size of the opening to be as large as possible, but “thin” as reasonably possible in the vertical dimension. The reasoning for this is to allow transmission of water from small slices of the water column, but maintain a relatively small head-loss across the gate.

In embodiments, substantially every depth in the water body at the location of the selector interface will coincide with one or another selector gates. In the case of an intake water selector, respective selector gates may be positioned at most every “upper” depth/elevation, and down into the lower depths of a reservoir. For an outfall water selector it may be preferred to have gates through the lower levels only. The selector openings/gates may be arranged side by side, in a zig-zag pattern down the face of the selector interface incorporated in the barrier. This zig-zag pattern avoids having two consecutive gates on top of one another, which has specific benefits. It is preferred that the gates be spaced at least 12″ apart in the width direction, and possibly more than 24″. An exemplary arrangement is diagrammatically illustrated in FIG. 4A which shows a plurality of selector gates 120 arranged on the selector interface 118. As can be seen, substantially every water depth between D1 and D2 coincides with one or another of the gates 120.

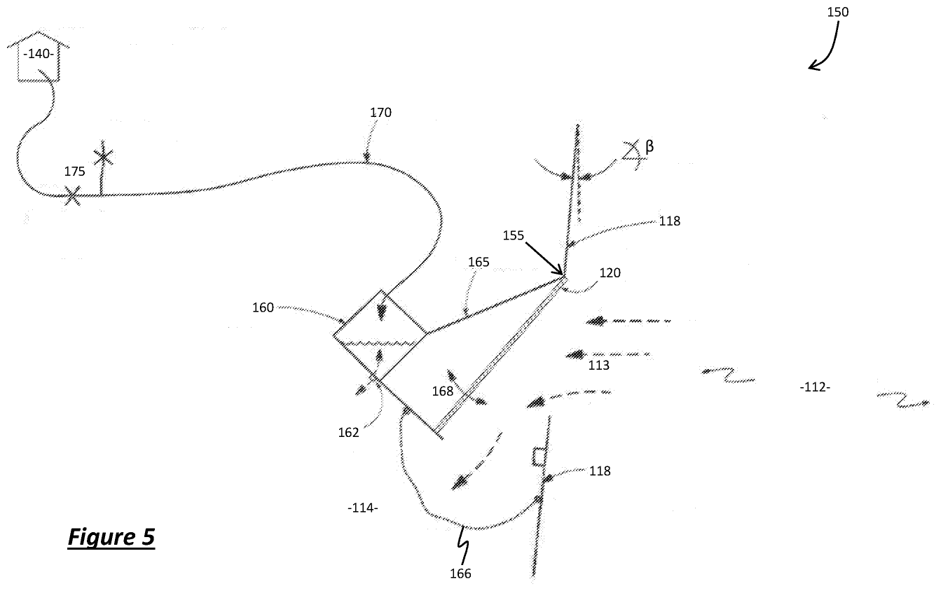

An example of a selector gate is and control apparatus 150 is shown in diagrammatic cross-section in FIG. 5. The gate 120 is pivotally coupled to the selector interface 118 by a horizontally oriented hinge 155 at the upper edge of the selector gate aperture. When closed the gate 120 blocks the aperture, but when the gate is open (as illustrated in the diagram) water is permitted to flow (as indicated by arrows 113) through the aperture from the main reservoir water body 112 into the partitioned water volume 114. In the apparatus 150 as shown the gate is operated pneumatically through controlled airflow in tubing 170. The air tubing 170 extends from a valve arrangement 175 operable by the control equipment 140 to supply compressed air to a buoyancy chamber 160 attached to the gate 120. The buoyancy chamber also has a vent hole 162 to admit or expel water.

When air is introduced to the buoyancy chamber 160 through the tubing 170, water is correspondingly expelled through the vent hole 162. This increases the buoyancy of the chamber 160 which is attached at the lower end of the hinged gate and laterally offset somewhat. In view of the lateral offset in conjunction with an ‘optimum angle’ ((3) of the selector interface relative to the vertical, the increased buoyancy of the chamber 160 causes the gate 120 to pivot about the hinge 155 in the direction indicated by arrow 168 so that the bottom of the gate separates from the interface 118 to allow the water flow 113 through the aperture. Pivotal displacement of the gate 120 is limited by a tether 166.

In order to close the gate 120 the valve arrangement 175 is controlled so as to vent air from the tubing 170 to atmospheric pressure, as a consequence of which water is permitted to flow into the buoyancy chamber through the vent hole 162. When the buoyancy has been sufficiently reduced the gate pivots on its own force of weight to rest against the selector interface surface and stop water flow through the aperture.

In embodiments the barrier curtains are supported by industrial strength floats at the top surface of the water, and hang down in the water column to the reservoir floor. At the reservoir floor, there may be excess curtain that extends outward (or inward) or horizontally in an “L” fashion where ballast is placed on top of it to seal it to the reservoir floor. Over time, silt and solids can fill up interstitial spaces along the curtain. As the water level in a reservoir drops, the curtain folds on top of itself, still hanging from the surface floats. Therefore a mechanism may be provided to selectively close and prevent operation of one or more lower gates, if necessary, and if water levels drop, gates from the bottom up will be closed off as the curtain folds. Thus, it may also be desirable to include a remotely operable latch mechanism between the gate and the selector interface (not shown) in order to resist unintended opening due to, for example, flexible deformation of the barrier structure and interface that may occur because of variation in water depth. The system is designed to take into account this possibility of dropping water levels and the impacts it has on the barrier face-wall that incorporates the selector interface and gates. The angled orientation of the selector interface illustrated in FIG. 5 may help facilitate correct ‘folding’ of the flexible barrier due to changing water levels in the reservoir.

One of the benefits of the use of a barrier structure to define a partitioned volume is that the preferred water admitted to the partitioned volume may be treated before exiting through the intake structure, for example. The partitioned volume defined by the barrier may be designed with a dimensional size and layout so that water within the barrier can potentially be treated in a number of steps and/or methods before it harvesting, and with sufficient detention time relative to the maximum harvesting rate of the water. Water admitted into the partitioned volume may be subjected to various forms of treatment or conditioning, including but not limited to oxidation (ex. aeration, permanganate, peroxide, ozone, peracetic acid, chlorine, etc.), dissolved air/gas flotation, carbon contacting, pH adjustment, alkalinity adjustment, coagulation, flocculation, filtration, heating/cooling, and other forms of treatment.

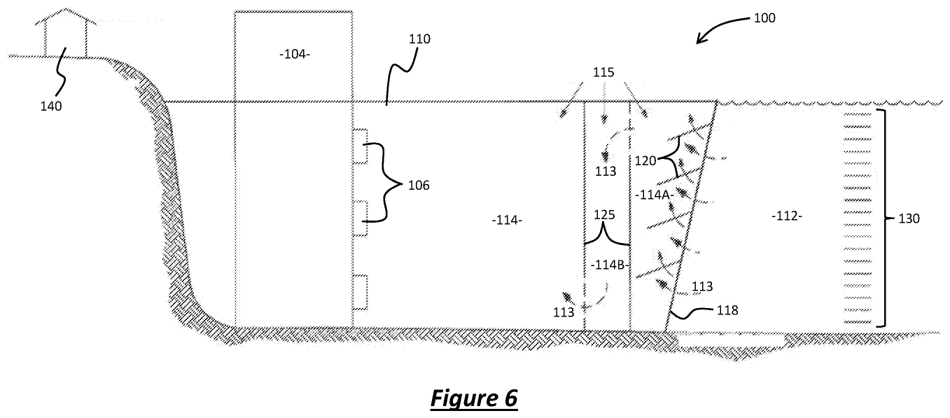

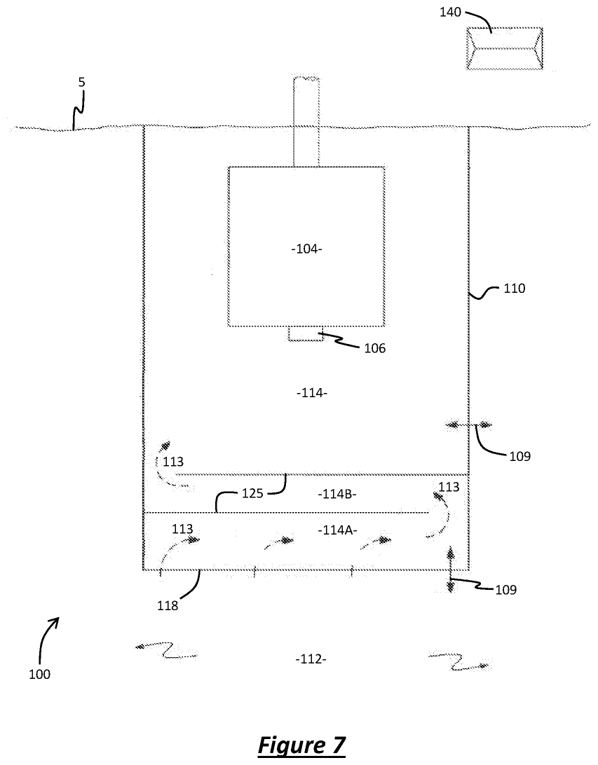

Multiple zones of treatment may be incorporated within the barrier separator structure to allow for sufficient treatment prior to water exiting the partitioned volume. A system including additional features designed to facilitate such treatment processes is illustrated in FIGS. 6 and 7. The system 100 shown in FIGS. 6 and 7 is constructed and operates in generally the same manner as that shown in FIG. 4, with the addition of intermediate baffle barriers 125 that are positioned between the selector interface 118 and the main partitioned volume 114. The intermediate baffle barriers form a circuitous path for the selected water that effectively creates a plurality of water pre-treatment zones 115, including the main partitioned volume 114 and additional zones 114A and 114B, which may be used to apply separate water treatment steps or processes. Water flow through the system is indicated by arrows 113. Pressure relief features in the barrier are diagrammatically indicated by arrows 109. Water in the main partitioned volume can be removed through the intake structure 104 by way of one or more outlets 106.

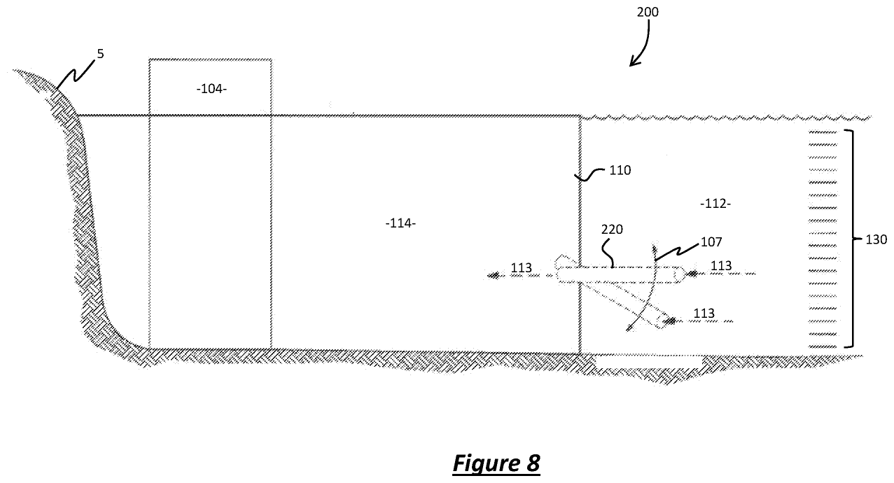

FIG. 8 illustrates another possible embodiment that may be used for implementing the principles of the present invention. In this diagrammatic side sectional view a system 200 is shown having an alternative water selector arrangement. Specifically, a selector pipe 220 is provided as a conduit between the main water body 112 and the partitioned volume 114. The pipe inlet located in the main water body is controllably adjustable for depth so that water at a selected depth in the reservoir can be admitted to the partitioned volume. The adjustable pipe arrangement 220 takes the place of the multiple selector gates 120 of the system 100 previously described. One or more adjustable pipes may be employed, as may be required or desirable according to the overall depth of the reservoir. The pipe may have a tilting arrangement as indicated by arrows 107 in the drawing, or may be flexible with an inlet opening depth controlled by a float and anchor system or ballast and buoyancy control system.

The preferred embodiments include the utilization of both a selector and barrier within the water body around or attached to an intake structure, outfall structure, or spillway, as this allows for several treatment benefits associated with the extraction/harvesting of water. However other forms are also contemplated, such as an alternative embodiment as illustrated in FIG. 9. This allows for the direct connection of a selector apparatus to a fixed-elevation harvesting device 255 (e.g. gate, pipe, etc.) that draws water dynamically from select depths around the intake structure, therefore allowing preferred water quality to go to the harvesting entity. In this case the selector apparatus comprises a pipe 220 that can be selectively adjusted in vertical angle (as indicated by arrows 107) in order to control the water depth at which the pipe inlet 221 is positioned. The pipe 220 in this construction is considered to be rigid, wherein the vertical angle (and thus the pipe inlet depth) is controllable by mechanical means such as a motorized gear or pulley arrangement or by use of a buoyancy control mechanism.

FIG. 10 shows another alternative arrangement in which a selector apparatus 300 is connected directly to a submerged intake 302 of an existing intake structure. In this case the submerged intake 302 (which may incorporate a screen to filter out debris) is coupled to an existing intake collection conduit 303 leading to an existing pump station 304. The selector apparatus 300 in this embodiment includes a pipe 310 that can be selectively controlled to adjust the water depth at which the pipe inlet 312 (which may include an integral screen) is positioned within the water body 112. The apparatus 300 includes a ballast 315 and buoyancy control chamber 316 coupled to the pipe 310 near the pipe inlet 312. Air (under pressure) can be fed into the buoyancy control chamber 316 (by means of an air tube, not shown) in order to increase the buoyancy and raise the pipe inlet 312 (for example, as shown at 312′). Conversely, air can be purged from the buoyancy chamber to decrease the buoyancy and lower the pipe inlet under the weight of the ballast and purge water. Water flow 313 from a selected water depth within the water body can thus be selected for provision to the intake 302, based for example on measured water quality as a function of depth, diagrammatically indicated at 330 in the drawing.

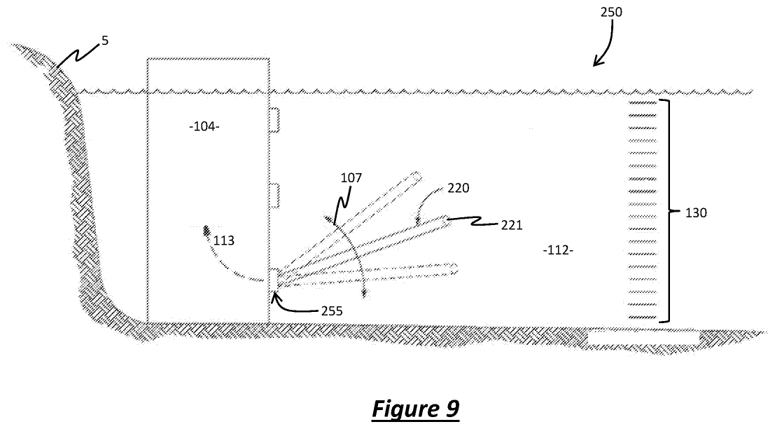

FIG. 11 shows a submerged intake adaptation 350 in which an existing intake collection conduit 303 is fitted with a plurality of discrete, individually controllable water selector gates 360A-D, each at a respective fixed depth. Although, in the embodiments of FIGS. 9, 10 and 11, limited opportunity exists to treat/pre-treat the selected water, it still allows for the selection of preferred water from a selected depth and/or locations within or about a body of water.

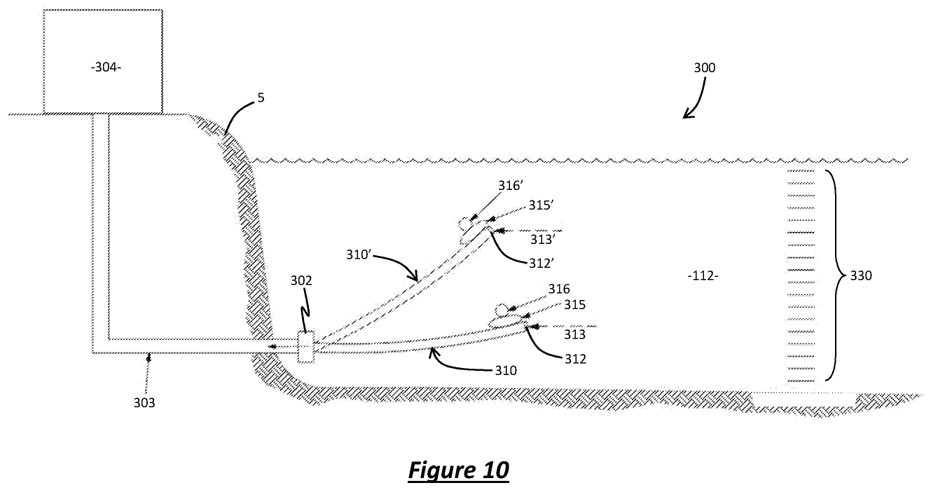

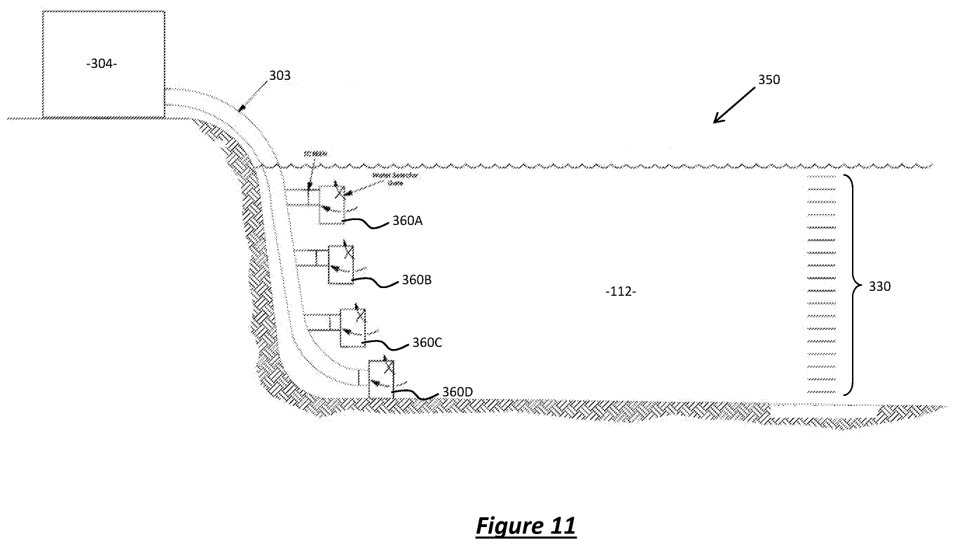

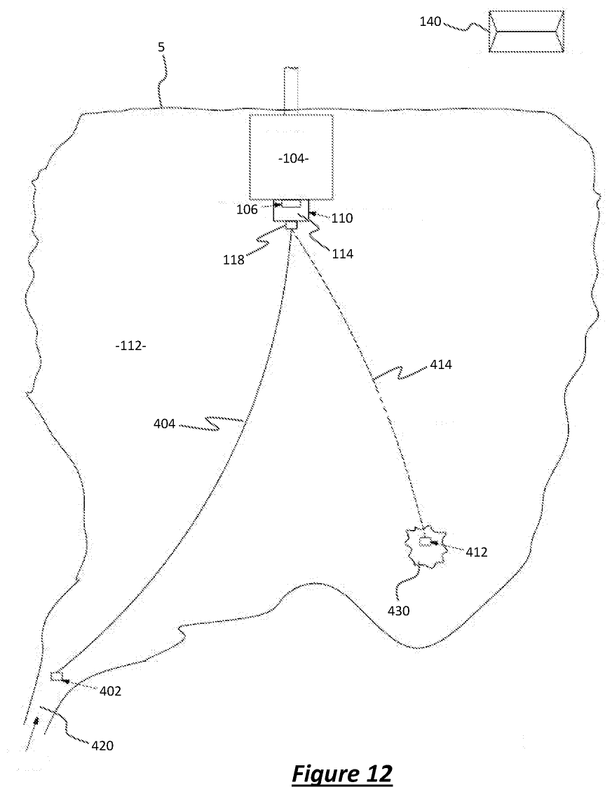

Another form of alternate embodiment as illustrated in FIG. 12 uses an apparatus located remotely from the intake structure that draws water dynamically from select locations within or in the vicinity of the water body for transmission to the harvesting entity. In the example shown here, the water body 112 is fed from one or both of two water sources—a river or stream indicated at 420, and a spring indicated at 430. The selector apparatus, in substitute for or in addition to controllable/selectable depth inlets, includes first and second selectable, location specific inlets 402, 412 positioned nearby the respective water sources 420, 430. The inlets 402, 412 are coupled to the selector interface 118 by way of respective conduits 404, 414. This arrangement allows for water to be selectively harvested from nearby the sources 420, 430, as an alternative to depth-selective harvesting.

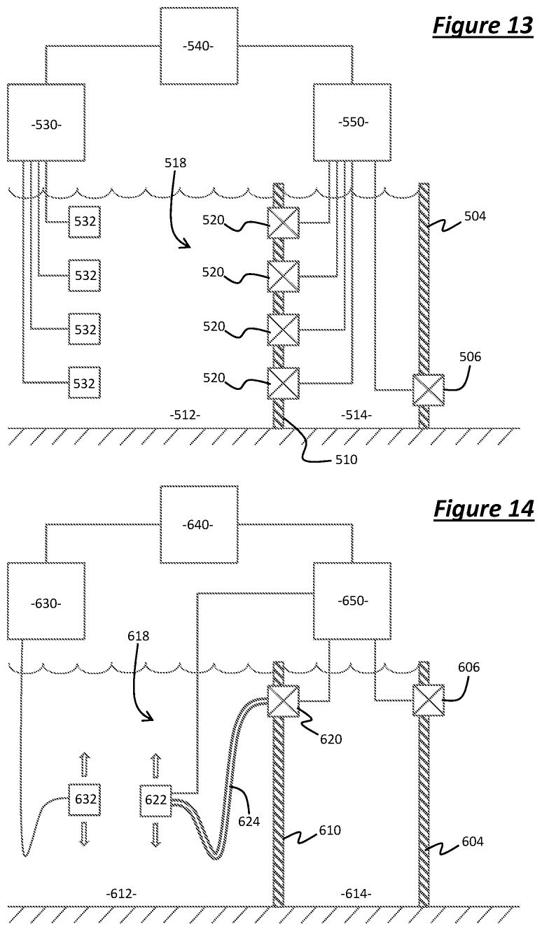

FIGS. 13 and 14 are diagrams illustrating generalized water selector systems according to embodiments of the invention. The system 500 shown in FIG. 13 is based on discrete water sampling and harvesting depths, whereas the system 600 shown in FIG. 14 is based on variable water sampling and harvesting depth. It will be appreciated that in practice a system may include a combination of these aspects.

FIG. 13 diagrammatically illustrates the system 500 installed in a water body 512 including a barrier 510 establishing a partitioned volume 514 between the barrier 510 and an intake structure 504. The system 500 includes apparatus for water quality measurement, in this case comprising a plurality of sensors or water sampling devices 532 arranged at respective discrete depths within the water body 512, the sensors or sampling devices being coupled to a water quality monitor 530. The water quality monitor 530 is coupled for communication with a control processor 540, which in turn is coupled for communication with a selector gate controller 550. The barrier 510 is provided with a selector interface 518 which includes a plurality of selector gates 520, coupled for control by the selector gate controller 550, for selectively admitting water from the water body 512 into the partitioned volume 514. The intake structure 504 has an outlet gate 506, which may also be controlled by the selector gate controller, or may be independently operable, and which allows for removal of water from the partitioned volume 514.

In use of the system 500 the water quality monitor 530 periodically measures water quality metrics using the sensors or sampling devices 532 at the respective depths/locations within the water body 512. Data concerning the measured water quality metrics are communicated to the control processor 540. Based on the measured water quality metrics at various depths/locations and predetermined desired water quality characteristics, the control processor 540 communicates with the selector gate controller 550 information as to which of one or more of the selector gates 520 should be opened/closed in order to admit water from the water body 512 into the partitioned volume 514. The selector gate controller 550 controls opening and closing of the selector gates 520 and/or outlet gate 506 accordingly.

FIG. 14 diagrammatically illustrates the system 600 installed in a water body 612 including a barrier 610 establishing a partitioned volume 614 between the barrier 610 and an intake structure 604. The system 600 includes apparatus for water quality measurement which in this case comprises a water quality monitor 630 coupled to a controllable variable depth sensor or water sampling devices 632. The water quality monitor 630 and controllable sensor or water sampling device 632 is operative to measure water quality metrics at various selected depths within the water body 612, which is communicated to a control processor 640. Based on the measured water quality metrics at various depths/locations and predetermined desired water quality characteristics, the control processor 640 communicates with a selector gate controller 650 information as to a particular depth within the water body with measured water quality metrics most closely matching the desired characteristics. The selector gate controller is operative to control a selector gate apparatus 618 which includes a controllable variable depth inlet 622 with a conduit 624 coupled to a selector gate 620. The selector gate controller, in use, acts to control the depth at which the inlet 622 is located, for example by buoyancy control or mechanical means as previously described, as well as the opening/closing of the selector gate 620, whereby to admit water from a selected depth within the water body 612 into the partitioned volume 614. Water can be removed from the partitioned volume 614 through an outlet gate 606 in the intake structure 604.

Those skilled in the art will appreciate that features of the systems 500, 600 may be interchangeable. For example, discrete depth water quality measurement may be used in a system with a single, variable control water selector inlet, and vice versa. Moreover, as previously described, in certain embodiments the selector gate apparatus may be directly coupled to the outlet gate of the intake structure, without a partitioned volume in between.

In a variation referred to herein as an ‘outfall’ embodiment the system may be used to monitor and control the withdrawal of selected water (quality) via a spillway or overflow. The intent is to permit controlled release of selected water, in this case typically having unfavorable characteristics (i.e. to get rid of the bad water in the reservoir). The outflow embodiment may be useful for improving or creating certain reservoir overall water quality condition and/or to affect downstream receiving waters. The mechanisms for monitoring and selecting that have been described in the specification in relation to the various other embodiments are also applicable to this outfall embodiment.

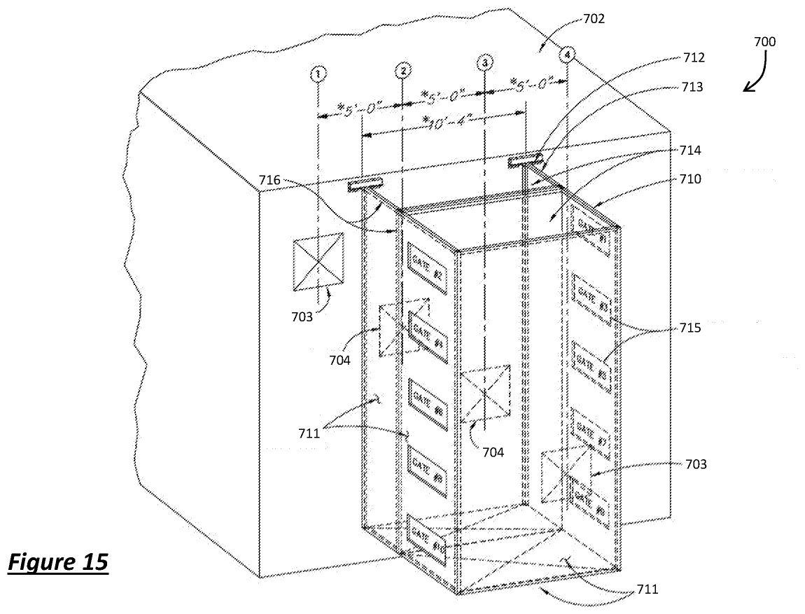

Earlier embodiments have predominantly been described in the context of a barrier formed from a flexible baffle curtain however, as mentioned, a fixed rigid structure may also be employed. FIG. 15 illustrates particular example of a system 700 in which a rigid assembly 710 is affixed directly to the intake structure 702 thereby providing the barrier. In the system 700 the intake structure has four existing gates (703, 704) and the rigid barrier structure (formed from metal—such as aluminium—or other relatively rigid material sheathing 711 on a frame 716) is affixed (712, 713) to the intake structure around two of the existing gates (704). The barrier structure has a selector arrangement that includes ten selector gates (e.g. 715) at respective depths, to selectively admit water from the respective depths into the volume enclosed between the barrier and the intake structure (714).

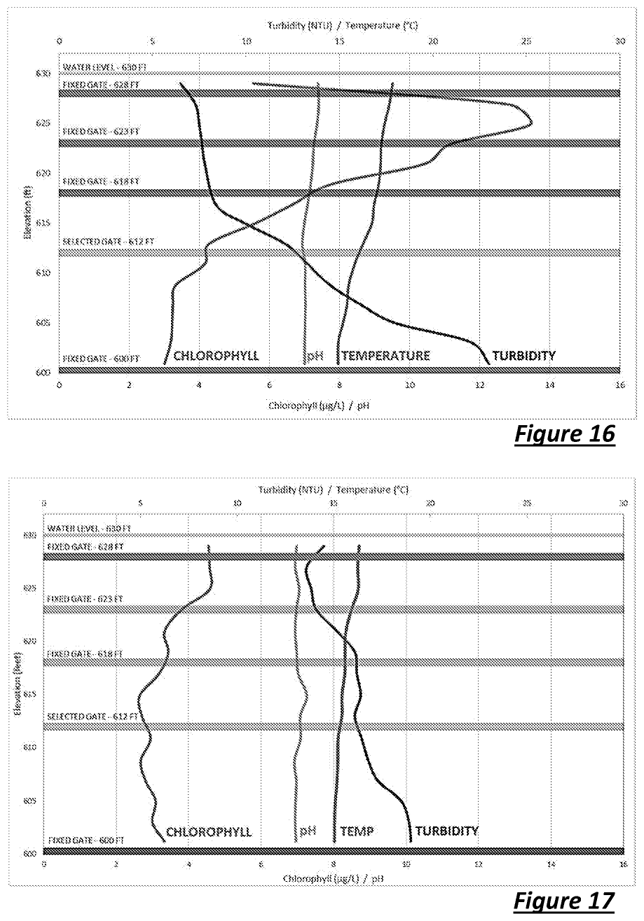

FIGS. 16-19 are graphs of experimentally measured water quality characteristics as a function of water depth in a water body equipped with a water selector apparatus according to an embodiment of the present invention, as discussed below.

FIG. 16 plots measures for chlorophyll, acidity (pH), temperature and turbidity in the water body as a function of elevation, wherein the water surface is at an elevation of 630 ft. This Figure reveals elevated concentrations of chlorophyll (presence of algae) in the upper ˜15 ft and a mild thermocline between elevations 615 ft and 610 ft. The data was collected in the afternoon when it might be expected that slightly cooler diurnal surface water temperature and somewhat increased phytoplankton activity would be observed. The turbidity is fairly low, 6 to 8 NTU, in the upper ˜10 ft of the water body, increasing quickly in the thermocline and even more rapidly through the hypolimnion.

The water harvesting plant intake gates that are normally used in this water body are those at elevation 618 ft and 623 ft (typically two gates are open to meet hydraulic requirements). Prior to installation of the experimental water selector apparatus, the WTP would experience raw water quality impacts associated with algae, i.e. taste & odor and TOC, as in this case, the chlorophyll levels would be about 10 μg/L transferred to the plant where pre-chlorination takes place. To respond to these conditions the plant typically dosed 18 ppm carbon prior to the rapid mix.

With the water selector apparatus installed and configured to provide preferred water from elevation 612 ft, the plant realized an improvement in raw water quality and was subsequently able to reduce the carbon dose to 12 ppm, a 33% decrease. While the preferred raw water had a slightly higher turbidity, the level did not require an increase in coagulant (alum) dosing.

FIG. 17 represents raw water quality data sampled from within the partitioned volume established by the water selector apparatus barrier. Generally, the water within the barrier consists of only water from the slice withdrawn from elevation 612 ft. While the plant intake open gates remained 618 ft and 623 ft, it was water from 612 ft within the main water body that was transferred to the plant. FIG. 17 illustrates how, within the barrier, the water throughout the profile varies little.

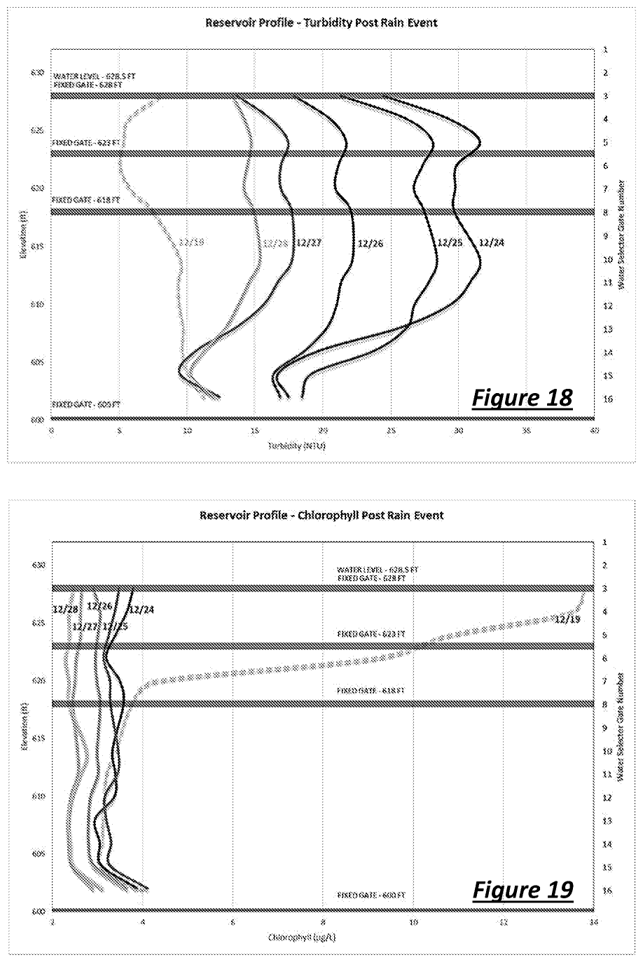

In the transition from autumn to winter in the region, the water body typically experiences seasonal turnover with cyclical colder and warmer days leading to relatively little stratification. However, this is also usually a wet time of year and rain events have historically proven especially impactful. The water body is in the vicinity of a large metropolitan area and is influenced by discharges and runoff. The water body typically turns brown and the turbidity influent to the plant can spike dramatically during rain events upstream along the river which feeds water into the reservoir. In late December 2015 a rainfall event measuring less than 1 inch in the upstream metropolitan area led to a turbidity spike at the plant to over 70 NTU and a corresponding increase in alum dose to 34 mg/L (over 50% increase). In December during the period of experimental observation, a similar rain event occurred in the metropolitan area and as a result a turbidity increase in the water body occurred. FIGS. 18 and 19 are plots of data representative of the raw water profile, for turbidity and chlorophyll, respectively, prior to and following the rain event. In these diagrams, elevation is indicated on the left-hand side vertical scale, with corresponding gate numbers of the water selector apparatus indicated on the right-hand side vertical scale.

With reference to FIG. 18, the turbidity on December 19 (12/19) peaked at about 10 NTU (not accounting for the water at the lake bottom where you would expect to see higher turbidity but would not typically choose to withdraw from that point). Most of the rain fell on December 20 measuring over 1 inch in the metropolitan area. The affected water plant operators report they usually experience the impact of upstream rains, at the intake, within a few days. At the time of the transient, water selector gate number 6 was selected, and influent turbidities were running about 5 NTU.

As seen in the graph, the turbidity spiked to over 30 NTU from about 3 ft below the surface to about 20 ft down on December 24. By selecting one of the lower gates, i.e. gate 13, 14 or 15, a much smaller turbidity increase would be experienced providing for less required adjustment for coagulation and a lower risk of a poor treatment outcome. By December 28, the turbidity had approached a new de-stratified profile.

Even during winter months with colder air and water temperatures, cyclical temperature transients and the resulting reservoir turnover and de-stratified profile, the water selector apparatus according to embodiments of the present invention can operate to smooth out water quality transitions caused by temperature swings and rain events. FIG. 19 illustrates shallow chlorophyll at elevated concentrations following a series of warm days (12/19). The rain event and cooling temperatures followed which resulted in a significant reduction in algae. While during this period, the preferred water selector gate would likely have been number 13, 14 or 15 (as discussed above), the use of the chlorophyll data confirms the importance of multi-parameter monitoring to ensure ideal gate selection.

The structure and implementation of embodiments of the invention has been described by way of non-limiting example only, and many additional modifications and variations may be apparent to those skilled in the relevant art without departing from the spirit and scope of the invention described.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A system for use with a water storage facility having a water body and an extraction structure, the system comprising a water selection apparatus interposed between the water body and the extraction structure, the water selection apparatus having a controllable inlet that allows water from a selectable depth within the water body to be harvested for withdrawal through the extraction structure.

2. A system according to claim 1, including a barrier structure forming a partitioned volume enclosing or attached to the extraction structure wherein the water selection apparatus controls water flow from the water body to the partitioned volume.

3. A system according to claim 2 wherein the barrier structure defines one or more water treatment zones through which, in use, water flows from the controllable inlet to the extraction structure.

4. A system according to claim 2 or 3 wherein the water selection apparatus comprises a selector interface integrated with the barrier structure and including a plurality of selector gates positioned at respective depths in the water body, the gates being selectively operable to admit water from the corresponding depth to the partitioned volume.

5. A system according to any one of claims 1 to 3 wherein the water selection apparatus comprises a fluid conduit such as a pipe having an inlet that is moveable to a selected depth within the water body.

6. A system according to any preceding claim including a monitoring apparatus arranged for measuring and monitoring at least one water quality characteristic over at a plurality of depths within the water body, wherein the water selection apparatus is controlled according to detected differences in the at least one water quality characteristic as between different depths.

7. A method for controlling the quality of water for withdrawal from a water body by way of an extraction structure, the method comprising selectively harvesting water from a dynamically controllable depth within the water body before admitting the harvested water for withdrawal through the extraction structure.

8. A method according to claim 7 including monitoring at least one water quality characteristic over at a plurality of depths within the water body and controlling the depth at which water is harvested according to detected differences in the at least one water quality characteristic as between different depths.

9. A method according to claim 7 or 8 including retaining the harvested water in a partitioned volume of the water body before withdrawal through the extraction structure.

10. A method according to claim 9 including applying at least one water treatment steps or processes to the water in the partitioned volume prior to withdrawal through the extraction structure.
